(19) United States
(12) Patent Application Publication
(10) Pub. No.: US 2004/0117051 A1
(43) Pub. Date: Jun. 17, 2004

(54) Method of determining a cumulative distribution function confidence bound

(76) Inventor: Dean M. Ford, Yorktown, IN (US)

Correspondence Address: BARNES & THORNBURG, 11 South Meridian Street, Indianapolis, IN, 46204, US

(21) Appl. No.: 09/875,754

(22) Filed: Jun. 6, 2001

Related U.S. Application Data
(60) Provisional application No. 60/209,676, filed on Jun. 6, 2000.

(51) Int. Cl. G06F 19/00

(52) U.S. Cl. 700/109

(57) ABSTRACT

Confidence levels on a probability distribution are analyzed based on data sets of varying size. Using a curve such as a Weibull distribution curve, computations can be made such as the odds that a percentage of a plurality of parts will fail after a prescribed time.

This application claims priority under 35 U.S.C. 119(e) to U.S. Provisional Application Serial No. 60/209,676, filed Jun. 6, 2000, which is expressly incorporated by reference herein.

### BACKGROUND AND SUMMARY OF THE INVENTION

The present invention relates to confidence bounds on cumulative distribution functions. More particularly, the present invention relates to a method of estimating the parameters of a probability distribution and any desired confidence level when provided with any number of data selected from a homogeneous population.

Probability distributions are used in a wide number of applications, particularly to predict the future occurrences of a particular event. For example, probability distributions may be used to determine the projected life span distribution of a group of manufactured parts, or to approximate the risk a life insurance company undertakes when insuring a particular individual. Numerous methods of analyzing probability distributions exist in the prior art. A common distribution which is known to adequately fit a wide range of phenomena is the Weibull distribution, which is disclosed further herein. However, the prior art cannot be relied upon to provide reliable estimates of confidence levels for arbitrarily censored data.

Typically, after a calculation has been made, one of any number of actions is taken, including creating a graphical representation of the calculated confidence bound, using the confidence bound to predict financial risks associated with occurrences over a period of time, creating a graphical representation of the calculations, using the calculations to predict costs associated with failure occurrences over a period of time, and using the calculations to determine whether to re-engineer the studied part.

One embodiment of the invention provides a substantially accurate method for analyzing confidence levels on a probability distribution. For example, given a probability distribution showing a number of occurrences N over a period of time T, the disclosed method can estimate with substantially accurate error calculation the percentage of time that will have transpired when 0.1 N (10% of the occurrences) has passed. In the alternative, the disclosed method can determine the number of occurrences that will be expected by a certain time, i.e. 0.1 T, 0.2 T, 0.8 T, etc.

Furthermore, a probability distribution can be formulated from data sets of varying size, including data sets consisting of as few as two observations. Additionally, substantially accurate confidence levels can be reliably determined for the same.

According to the disclosure, data can be utilized that would have traditionally been considered flawed, such as a part failure that occurred between shifts or at a time that can not be exactly determined. For example, if during part testing, a failure occurs during an unsupervised period sometime between 5 p.m. and 5 a.m. the next morning, the prior art would require methods which do not allow for accurate confidence bound calculation. According to the present disclosure, however, this data would be completely compatible with the method.

In another embodiment of the invention, a method is used for determining the probability that a percentage of a plurality of parts will fail after a given time using a sample of part failures and the Weibull distribution type. The disclosed method includes choosing an initial percentage and a value for a random variable for use as a limit in the Weibull distribution type, wherein the Weibull distribution type has a scale parameter and a shape parameter. A first plurality of logarithmic ranges is defined, wherein the scale parameter has a substantially equal probability of occurring. A second plurality of logarithmic ranges is also defined, wherein the shape parameter has a substantially equal probability of occurring. A two-dimensional array of probabilities of obtaining the sample of part failures is then determined, wherein one dimension of the array is the first plurality of logarithmic ranges, and a second dimension of the array is the second plurality of logarithmic ranges. Next, a level of significance of the values of the probabilities is determined, and the two-dimensional array is discontinued when the values do not meet that level of significance. The Weibull distribution type is used to create an associated second array of percentages based on the chosen random variable, an associated shape parameter, and an associated scale parameter, wherein the associated shape parameter and the associated scale parameter relate to the particular location on the array of probabilities. The array of probabilities is then divided into parts (illustratively, two parts) based on whether the associated second array of percentages are above or below the chosen initial percentage. Next a first sum of all of the values of the array of probabilities is determined and then a second sum of all of the values of one of the parts of the probabilities is determined. The first sum and the second sum are compared to determine the probability that a percentage of a plurality of parts will fail after the given time. Finally, one of a plurality of actions is taken, the action being selected from the following: creating a graphical representation of the comparison, using the comparison to predict costs associated with failure occurrences over a period of time, and using the comparison to determine whether to re-engineer the part. However, it should be understood that other actions are within the scope of the disclosure. For example, once the probability is determined as discussed above, it is anticipated that any number of other actions may follow from that determination.

In another illustrative embodiment, a method of determining a cumulative distribution function confidence bound comprises the steps of providing a plurality of test data; selecting a distribution model having a first parameter and a second parameter, wherein the distribution model is defined by a cumulative distribution function that is a function of a random variable; assigning numeric values to the cumulative distribution function and the random variable such that the first parameter is a function of the second parameter; determining a likelihood function from the test data and the distribution model; integrating the likelihood function up to a selected limit in order to calculate a numerator, the selected limit being defined by the relationship between the first parameter and the second parameter; integrating the entire likelihood function in order to calculate a denominator; and calculating the confidence bound by dividing the numerator by the denominator. The distribution model can be a Weibull distribution, a Gamma distribution, a Beta distribution, a Gaussian distribution, or an F distribution. The method can additionally include the step of changing the value of one of the cumulative distribution function and the random variable such that the calculated confidence bound substantially equals a desired value.

In an illustrative embodiment, the first parameter is a scale parameter and the second parameter is a shape parameter. The incremental volume under the likelihood function is defined by the product of the likelihood function, a change in the logarithm of the first parameter, and a change in the logarithm of the second parameter. According to this embodiment, the incremental volume under a quotient of the likelihood function and one of the first parameter and the second parameter is defined by the product of the quotient, a change in the first parameter, and a change in the logarithm of the second parameter. The incremental volume under a quotient of the likelihood function and the product of the first parameter and the second parameter is defined by the product of the quotient, a change in the first parameter, and a change in the second parameter.

The disclosed illustrative embodiment allows for confidence bound calculation with bounds defined as confidence on reliability given a specified life value, as well as confidence bound calculation with bounds defined as confidence on life given a specified reliability.

### BRIEF DESCRIPTION OF THE DRAWINGS

The detailed description particularly refers to the accompanying figures in which:

FIG. 1a is a flow chart showing one embodiment of the disclosed method that is used to calculate the confidence levels given certain input values;

FIG. 1b is a flow chart showing another embodiment of the disclosed method;

FIG. 1c is a flow chart showing yet another embodiment of the disclosed method;

FIG. 2 is a graph of a likelihood function;

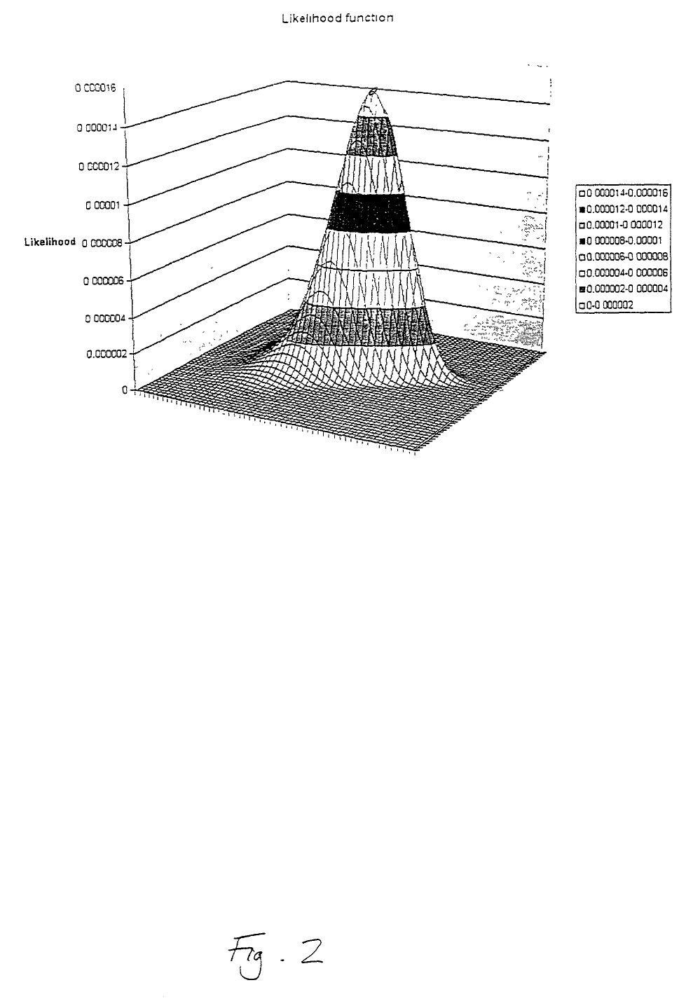

FIG. 3 is a chart of the results of the disclosed method, showing a distribution curve positioned between a lower confidence level curve and an upper confidence level curve;

FIG. 4 is a plot of the P(S|θ) function;

FIG. 5 is a graph showing the value of CL(θ_{b}) as a function of θ, further noting where the function crosses the 0.9, 0.5, and 0.1 values;

FIG. 6 shows the surface which defines the volume;

FIG. 7 shows the same volume, but only the portion above a certain value of m which has been chosen so that the ratio of this volume to the complete volume is about 0.5;

FIG. 8 shows a two dimensional view of confidence bounds for m and θ;

FIG. 9 shows the contours of constant life at 1% failure fraction (99% reliability);

FIG. 10 shows the lines of constant failure fraction at a life of 6 hours; and

FIG. 11 is a graph showing the confidence levels on m.

### DETAILED DESCRIPTION OF THE DRAWINGS

The following example illustratively relates to a manufactured part, however, it should be understood that the methods disclosed herein are applicable to any probability distribution or set of data where confidence levels may be desired. The following also illustratively discusses the application of the disclosed method to a Weibull distribution, or similar distribution. However, the scope of the invention is not limited to such an application.

It is desirable for a manufacturer of a mechanical part to have some approximation as to the longevity of the manufactured part. Such an approximation is useful in evaluating the longevity of a device incorporating the part, the additional costs associated with the part due to replacement or repair, or the potential risks associated with the failure of the part. When a number of identical mechanical parts are tested for duration until failure, however, the parts generally demonstrate widely varied failure times, thereby hindering the predictability of the failure of a given part. For example, if a selected number of identical brake parts for an automobile are tested, one or two parts may fail after as few as 50,000 uses (or units), while another may last 1,000,000 uses, with the mean, for example, falling in the 300,000 uses range. It is also desirable for a manufacturer of such a part to determine the probability of failure at a given time. It is assumed in the following distributions and equations that occurrences (i.e. part failures) are independent from each other.

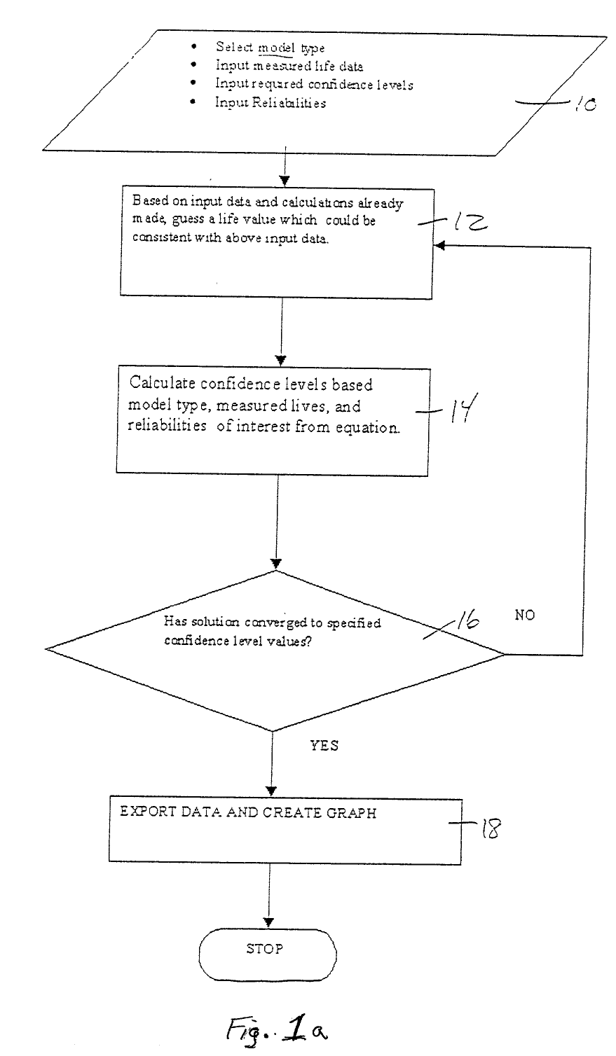

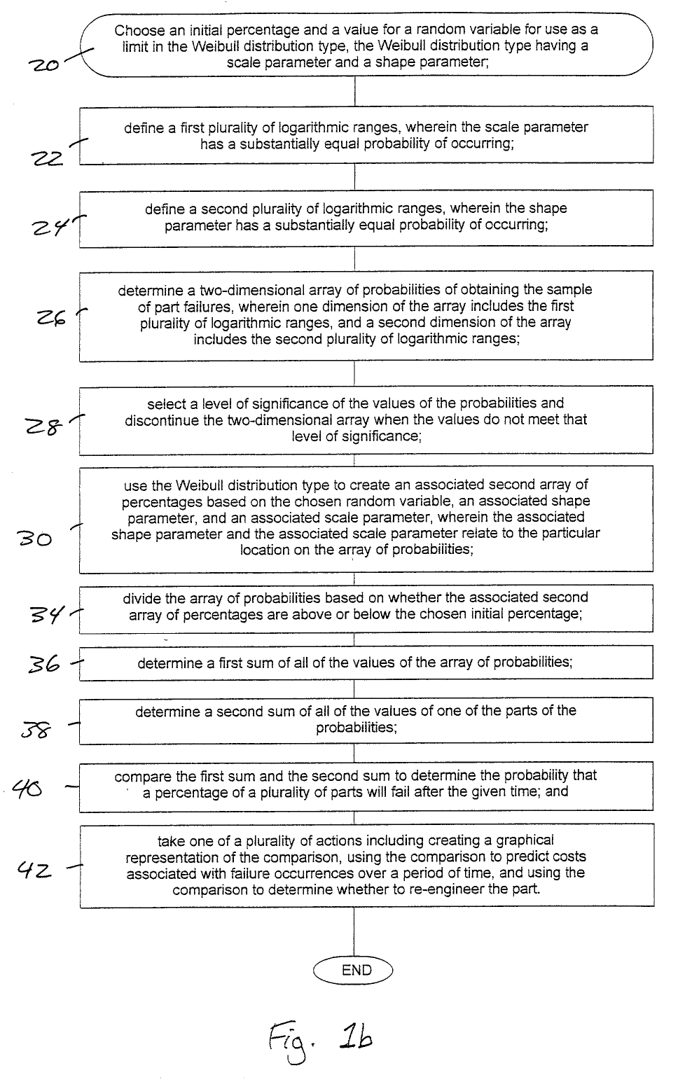

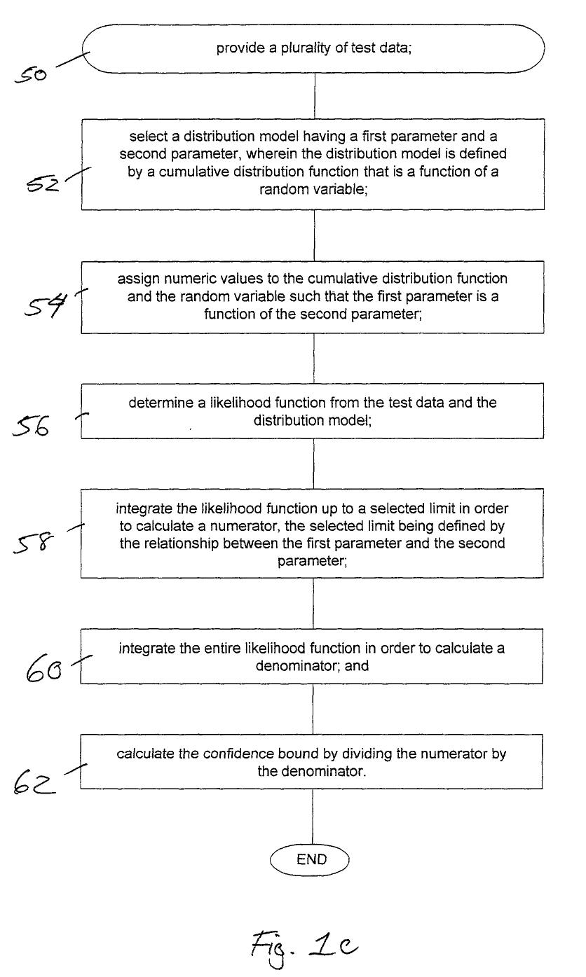

FIG. 1a shows an illustrative embodiment of a method of calculating a probability distribution for a series of occurrences such as a manufactured part failure given data indicative of past or test occurrences. The first step 10 includes selecting a model type and inputting measured data, reliabilities at which lives are to be calculated, and the desired confidence levels. For example, the measured data could be input, as well as a desired confidence level. The model type selection reflects whether a Weibull model is being used, or other type of model. Reliabilities can be defined as calculated, estimated, or known values relating to the reliability of the part—for instance, what has been predicted based on simulated tests performed prior to actual use. Step 12 considers the above—entered data and guesses a reasonable value (e.g., failure time) consistent with the data. Step 14 calculates the confidence levels based on the entered data and the guessed value using the algorithm disclosed in more detail below. Step 16 then determines whether the calculated confidence level has converged to the desired confidence level. If there is a convergence, the data is exported and a probability distribution with a confidence level can be graphed, as indicated by step 18. If there is no convergence, the method requires the return to step 12.

FIG. 1b illustrates another embodiment of the present disclosure. A method is disclosed of determining the probability that a percentage of a plurality of parts will fail after a given time using a sample of part failures and the Weibull distribution type. The disclosed method begins with choosing an initial percentage and a value for a random variable for use as a limit in the Weibull distribution type, wherein the Weibull distribution type has a scale parameter and a shape parameter. This step is indicated with the numeral 20. According to step 22, a first plurality of logarithmic ranges is defined, wherein the scale parameter has a substantially equal probability of occurring. In step 24, a second plurality of logarithmic ranges is also defined, wherein the shape parameter has a substantially equal probability of occurring. A two-dimensional array of probabilities of obtaining the sample of part failures is then determined in step 26, wherein one dimension of the array is the first plurality of logarithmic ranges, and a second dimension of the array is the second plurality of logarithmic ranges. Next, in step 28, a level of significance of the values of the probabilities is selected, and the two-dimensional array is discontinued when the values do not meet that level of significance. According to step 30, the Weibull distribution type is used to create an associated second array of percentages based on the chosen random variable, an associated shape parameter, and an associated scale parameter, wherein the associated shape parameter and the associated scale parameter relate to the particular location on the array of probabilities. The array of probabilities is then divided into parts in step 34, based on whether the associated second array of percentages are above or below the chosen initial percentage. A first sum of all of the values of the array of probabilities is determined in step 36 and then a second sum of all of the values of one of the parts of the probabilities is determined in step 38. The first sum and the second sum are compared in step 40 to determine the probability that a percentage of a plurality of parts will fail after the given time. Finally, in step 42, one of a plurality of actions is taken, the actions being either creating a graphical representation of the comparison, using the comparison to predict costs associated with failure occurrences over a period of time, or using the comparison to determine whether to re-engineer the part.

In another illustrative embodiment portrayed in FIG. 1c, a method of determining a cumulative distribution function confidence bound comprises the following steps. In step 50, a plurality of test data is provided. A distribution model having a first parameter and a second parameter is selected in step 52, wherein the distribution model is defined by a cumulative distribution function that is a function of a random variable. According to step 54, numeric values are assigned to the cumulative distribution function and the random variable such that the first parameter is a function of the second parameter. A likelihood function is determined from the test data and the distribution model in step 56. The likelihood function is then integrated in step 58 up to a selected limit in order to calculate a numerator, the selected limit being defined by the relationship between the first parameter and the second parameter. The entire likelihood function is integrated in step 60 in order to calculate a denominator. Finally, the confidence bound is calculated in step 62 by dividing the numerator by the denominator, as defined above.

The distribution model can be a Weibull distribution, a Gamma distribution, a Beta distribution, a Gaussian distribution, or an F distribution. The method can additionally include the step (not shown in FIG. 1c) of changing the value of one of the cumulative distribution function and the random variable such that the calculated confidence bound substantially equals a desired value.

As noted above, a Weibull distribution can be utilized in the disclosed method. A Weibull distribution is a well-known tool which estimates reliability from test data. A Weibull distribution can be easily calculated and plotted if not already known. The Weibull distribution is defined by the cumulative distribution function (cdf):

$$F ( x ) = 1 - {{ⅇ}^{- ( \frac{x}{θ} )}}^{m}$$

or the probability density function (pdf):

$$f ( x ) = \frac{m}{θ} \cdot {( \frac{x}{θ} )}^{m - 1} {{ⅇ}^{- ( \frac{x}{θ} )}}^{m}$$

Assuming there is a Weibull distribution, probabilities are determined in the following fashion. The probability of obtaining a sample S given the parameters m and θ is given as:

$$P ( s \vert m , θ ) = \frac{m}{θ} \cdot {( \frac{x}{θ} )}^{m - 1} \cdot {{ⅇ}^{- ( \frac{x}{θ} )}}^{m}$$

where s=single part failure data, and x=an exact time or load value. Knowing these exact time or load values, the “likelihood function” equation can be written, which is the product of the individual measurement probabilities:

$$P ( S \vert m , θ ) = {\prod }_{r}^{} P ( {s}_{r} \vert m , θ )$$

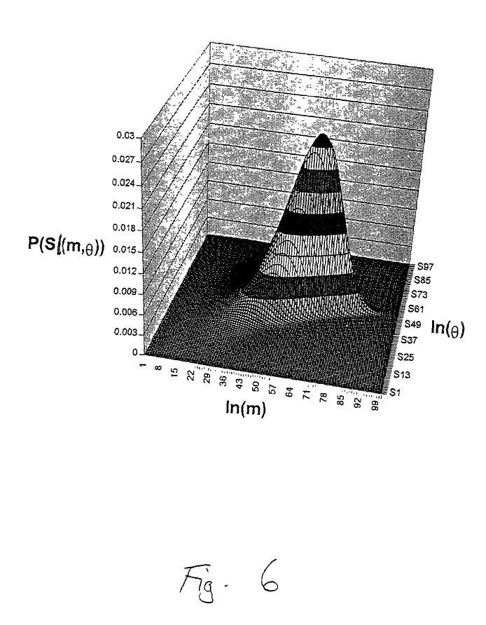

An example of the graph of a likelihood function can be seen in FIG. 6, where the likelihood is a function of w and Φ, w=ln(m), and Φ=ln(θ).

If an exact time or load value is not known, but instead it is known that a part failed after time xₐ, and before time x_{b}, then the following equation is used:

$$P ( s \vert m , θ ) = {{ⅇ}^{- ( \frac{{x}_{a}}{θ} )}}^{m} - {{ⅇ}^{- ( \frac{{x}_{b}}{θ} )}}^{m}$$

In order to determine the volume under the likelihood function surface when two unknown parameters define the distribution, a double integral is necessary. Any parameter for which a confidence bound is being calculated will divide the volume into two parts. The ratio of the volume on one side of the parameter to the total volume is, according to the disclosure, the confidence level equation.

$$C L = \frac{{\int }_{w = - ∞}^{∞} {\int }_{φ = l n ( x ) - \frac{1}{m} l n ( - l n ( 1 - f f ) )}^{∞} P ( S \vert m , θ ) ⅆ φ ⅆ w}{{\int }_{w = - ∞}^{∞} {\int }_{φ = - ∞}^{∞} P ( S \vert m , θ ) ⅆ φ ⅆ w}$$

where:

m=Weibull slope

θ=characteristic life

w=ln(m)

Φ=ln(θ)

ff=failure fraction (1-reliability)

x=life at failure fraction and confidence level

The failure fraction, ff, is the fraction of parts from a large population which will have failed at a particular value of load, time, or cycles. The characteristic life, or θ, is the life value at which 63.2% of the products have failed, and is used as a scale to rate the lifespan of a part. For example, a population of parts with a characteristic life of 20 will exhibit twice the life as compared to a population of parts with a characteristic life of 10.

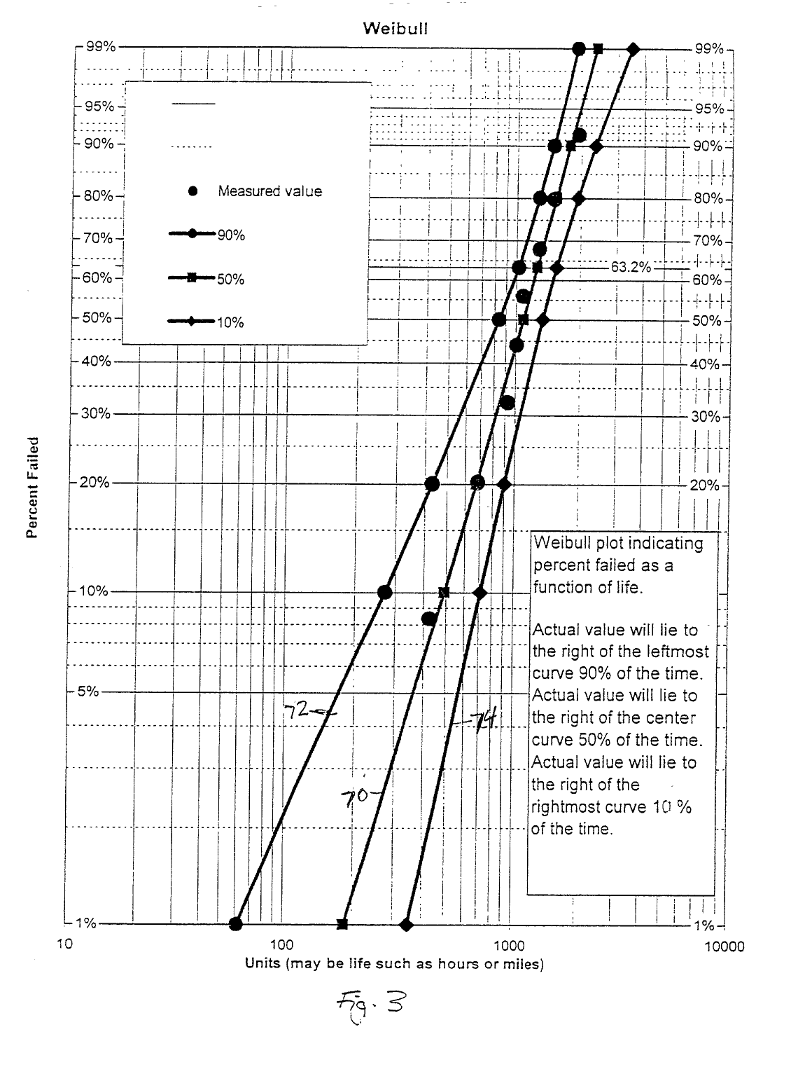

From the above equations, a plot can be drawn as shown in FIG. 3 such that confidence levels are indicated on a chart of units versus percent failed. As shown in FIG. 3, the Weibull distribution curve 70 is positioned between a lower confidence bound 72 and an upper confidence bound 74. If confidence bounds of 10% and 90% are desired, for example, the 90% confidence bound 72 indicates the point where the total large population fraction of parts which will fail before a particular countable unit (i.e. hours, miles, or other) will be less than the confidence bound 72 ninety percent of the time, while only being greater than the confidence bound 72 ten percent of the time. Similarly, the 10% confidence bound 74 indicates the point where the large population fraction of parts which will fail before such a unit in time will be less than the confidence bound 74 ten percent of the time, and will be greater than the confidence bound 74 ninety percent of the time.

### EXAMPLE PROBLEM 1

A common distribution used in reliability analysis is the exponential distribution. It is actually a special case of the Weibull distribution where the Weibull slope is equal to 1. It therefore has only a single parameter θ which determines the distribution. In the Weibull formulation, this would be referred to as the characteristic life, but for the exponential distribution it is referred to as the mean time to failure (MTTF).

The cumulative distribution function is:

$$F ( x ) = 1 - {ⅇ}^{- ( \frac{x}{θ} )} \qquad ( Eq . 1 )$$

And the probability density function is the derivative which is:

$$f ( x ) = \frac{1}{θ} \cdot {ⅇ}^{- ( \frac{x}{θ} )} \qquad ( Eq . 2 )$$

If it has been established from previous tests that the life of resistors on a particular test follows an exponential distribution, when a random sample of 3 resistors from a large population were selected for a qualification test and they exhibited failures at 7, 8, and 9 hours, the disclosed method would take the following approach to determine the confidence bounds on the MTTF. Since the MTTF is the only parameter of the distribution, determination of the confidence on the MTTF completely defines the confidence on any part of the distribution. For this example, we will determine the 90%, 50%, and 10% confidence levels on the MTTF. However, any confidence level value could be similarly requested.

The probability per unit time of the first part failing at seven hours is given by

$$P ( {s}_{1} \vert θ ) = \frac{1}{θ} \cdot {ⅇ}^{- ( \frac{7}{θ} )} \qquad ( Eq . 3 )$$

Similarly the probabilities of the second and third parts failing at 8 and 9 hours are given by:

$$P ( {s}_{2} \vert θ ) = \frac{1}{θ} \cdot {ⅇ}^{- ( \frac{8}{θ} )} P ( {s}_{3} \vert θ ) = \frac{1}{θ} \cdot {ⅇ}^{- ( \frac{9}{θ} )} \qquad ( Eq . 4 , 5 )$$

The probability of the sample (collection of individual failures) is then the product of the three:

$$P ( S \vert θ ) = \frac{1}{θ} \cdot {ⅇ}^{- ( \frac{7}{θ} )} \cdot \frac{1}{θ} \cdot {ⅇ}^{- ( \frac{8}{θ} )} \cdot \frac{1}{θ} \cdot {ⅇ}^{- ( \frac{9}{θ} )} \qquad ( Eq . 6 )$$

which will simplify to:

$$P ( S \vert θ ) = \frac{1}{{θ}^{3}} \cdot {ⅇ}^{- ( \frac{24}{θ} )} \qquad ( Eq . 7 )$$

The confidence levels are obtained by integrating this equation with respect to a variable Φ which is equal to the ln(θ).

$$C L ( {θ}_{b} ) = \frac{{\int }_{φ = l n ( {θ}_{b} )}^{∞} \frac{1}{{θ}^{3}} \cdot {ⅇ}^{- ( \frac{24}{θ} )} ⅆ φ}{{\int }_{φ = - ∞}^{∞} \frac{1}{{θ}^{3}} \cdot {ⅇ}^{- ( \frac{24}{θ} )} ⅆ φ} \qquad ( Eq . 8 )$$

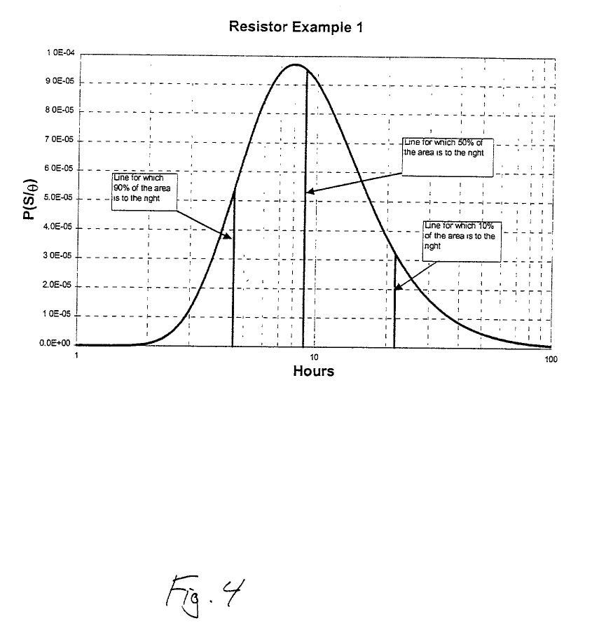

FIG. 4 is a plot of the P(S/θ) function. The vertical lines divide the area under the curve such that 90%, 50%, and 10% of the total area is to the right of the line. The life values which correspond to these divisions are the 90%, 50%, and 10% confidence bounds on the MTTF.

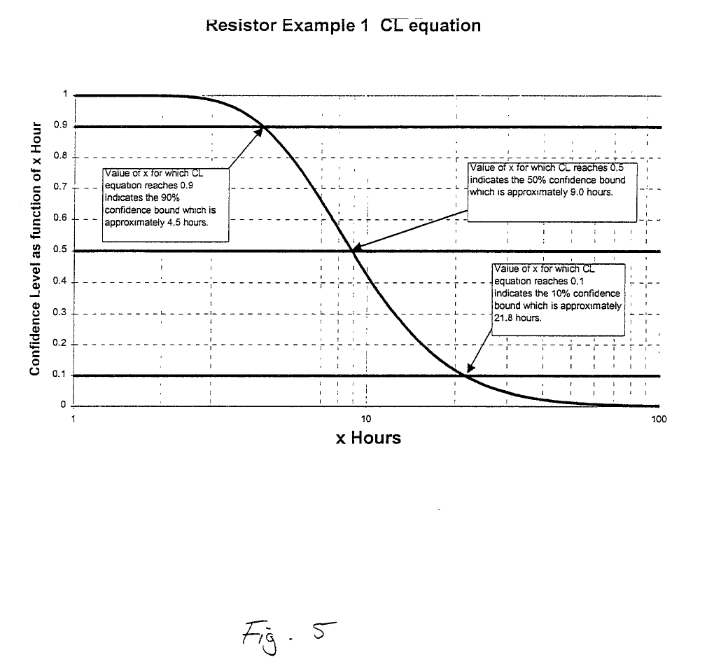

An alternative way of graphing the result is shown in FIG. 5, wherein the value of CL(θ_{b}) is graphed as a function of θ and it is determined where the function crosses the 0.9, 0.5, and 0.1 values. These graphs are just two different ways of visualizing the solution to equation 8.

The question of when a small percentage will have failed is often of interest. For example, the life at which 1% of the parts will have failed is referred to as the B1 Life. If the MTTF to failure is known, the B1 life can be determined by the inverse of the cumulative distribution function.

B1 life=MTTF·(−ln(1−0.01)) (Eq. 9)

The answer for the confidence levels on the MTTF and B1 life are:

TABLE 1-1

| Confidence Level | MTTF | B1 life |
|---|---|---|
| 90% | 4.5 hours | 0.045 hours |
| 50% | 9.0 hours | 0.090 hours |
| 10% | 21.8 hours | 0.219 hours |

This completes sample 1. This problem is not beyond the use of tools already available but is included to demonstrate the use of the equation 8. This problem would conventionally be solved using chi-squared distributions with almost identical results. However, even this single parameter problem becomes not readily solvable with accurate confidence bounds if arbitrary censoring is introduced. For example if 2 more resistors were included in the study, one of which was removed from the test at 7.5 hours, and one of which failed sometime in the interval between 10 and 11 hours, this algorithm would solve in the identical fashion.

### EXAMPLE PROBLEM 2

A common distribution used in reliability analysis is the Weibull distribution which is discussed elsewhere in the patent application. It has two parameters θ and m which determine the distribution.

The cumulative distribution function is:

$$F ( x ) = 1 - {{ⅇ}^{- ( \frac{x}{θ} )}}^{m} \qquad ( Eq . 10 )$$

And the probability density function is the derivative which is:

$$f ( x ) = \frac{m}{θ} \cdot {( \frac{x}{θ} )}^{m - 1} {{ⅇ}^{- ( \frac{x}{θ} )}}^{m} \qquad ( Eq . 11 )$$

If it has been established from previous tests that the life of resistors on a particular test follows a Weibull distribution, when a random sample of 3 resistors from a large population was selected for a qualification test and the resistors exhibited failures at 7, 8, and 9 hours, the following approach would be appropriate to determine the confidence bounds on θ, m, the life given a failed fraction, or a failed fraction given a life. For this example, we will determine the 90%, 50%, and 10% confidence levels on θ, m, on the life at which 1% will have failed (B1 life) and the percentage failed at 6 hours. However, any confidence level value could be similarly requested.

The probability per unit time of the first part failing at seven hours is given by

$$P ( {s}_{1} \vert ( m , θ ) ) = \frac{m}{θ} \cdot {( \frac{7}{θ} )}^{m - 1} {{ⅇ}^{- ( \frac{7}{θ} )}}^{m} \qquad ( Eq . 12 )$$

Similarly the probabilities of the second and third parts failing at 8 and 9 hours are given by:

$$\begin{matrix}P ( {s}_{2} \vert ( m , θ ) ) = \frac{m}{θ} \cdot {( \frac{8}{θ} )}^{m - 1} {{ⅇ}^{- ( \frac{8}{θ} )}}^{m} \\ P ( {s}_{2} \vert ( m , θ ) ) = \frac{m}{θ} \cdot {( \frac{9}{θ} )}^{m - 1} {ⅇ}^{- {( \frac{9}{θ} )}^{m}} \end{matrix} \qquad ( Eq . 13 , 14 )$$

The probability of the sample (collection of individual failures) is then the product of the three:

$$P ( S \vert ( m , θ ) ) = \frac{m}{θ} \cdot {( \frac{7}{θ} )}^{m - 1} \cdot {ⅇ}^{- ( \frac{7}{θ} )} \cdot \frac{m}{θ} \cdot {( \frac{8}{θ} )}^{m - 1} \cdot \\ {ⅇ}^{- ( \frac{8}{θ} )} \frac{m}{θ} \cdot {( \frac{9}{θ} )}^{m - 1} \cdot {ⅇ}^{- ( \frac{9}{θ} )} \qquad ( Eq . 15 )$$

which will simplify to:

$$P ( S \vert ( m , θ ) ) = \frac{{m}^{3}}{{θ}^{3}} \cdot {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} \qquad ( Eq . 16 )$$

Equation 16, because it is a function of two parameters, m and θ, describes a surface rather that a curve as seen in Example 1. The confidence levels are obtained by integrating the volume under this equation. If we wish to calculate confidence on the slope m, we integrate the volume under the surface above a given value of m_{b} and compare that to the total volume, shown graphically in FIG. 6.

This is done on a logarithmic basis, so define

w=ln(m)

Φ=ln(θ)

m_{b} is the confidence bound on m

θ_{b} is the confidence bound on θ

Then

$$C L ( {m}_{b} ) = \frac{\begin{matrix}{\int }_{w = l n ( {m}_{b} )}^{∞} {\int }_{φ = - ∞}^{∞} \frac{{m}^{3}}{{θ}^{3}} \cdot {( \frac{7 \cdot 8 \cdot 9}{{θ}^{3}} )}^{m - 1} \cdot \\ {ⅇ}^{- ( \frac{{7}^{m} + {8}^{m} + {9}^{m}}{{θ}^{m}} )} ⅆ φ ⅆ w\end{matrix}}{{\int }_{w = - ∞}^{∞} {\int }_{φ = - ∞}^{∞} \frac{{m}^{3}}{{θ}^{3}} \cdot {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} ⅆ φ ⅆ w} \qquad ( Eq . 17 )$$

$$CL ( {θ}_{b} ) = \frac{{\int }_{w = - ∞}^{∞} {\int }_{φ = ln ( {θ}_{b} )}^{∞} \frac{{m}^{3}}{{θ}^{3}} \cdot {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} ⅆ φ ⅆ w}{{\int }_{w = - ∞}^{∞} {\int }_{φ = - ∞}^{∞} \frac{{m}^{3}}{{θ}^{3}} \cdot {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} ⅆ φ ⅆ w} \qquad ( Eq . 18 )$$

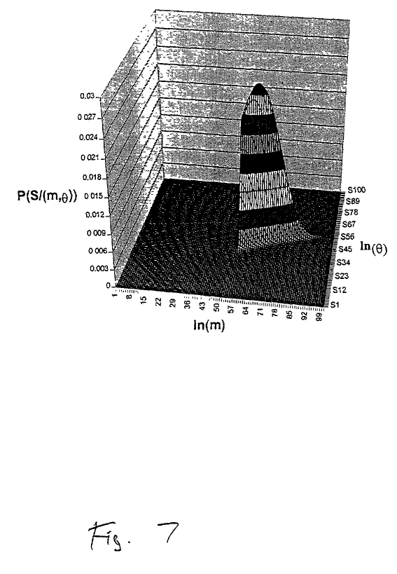

FIG. 7 shows the same volume, but only the portion above a certain value of m which has been chosen so that the ratio of this volume to the complete volume is about 0.5. This establishes the value of m which corresponds to a CL of 0.5 or 50%.

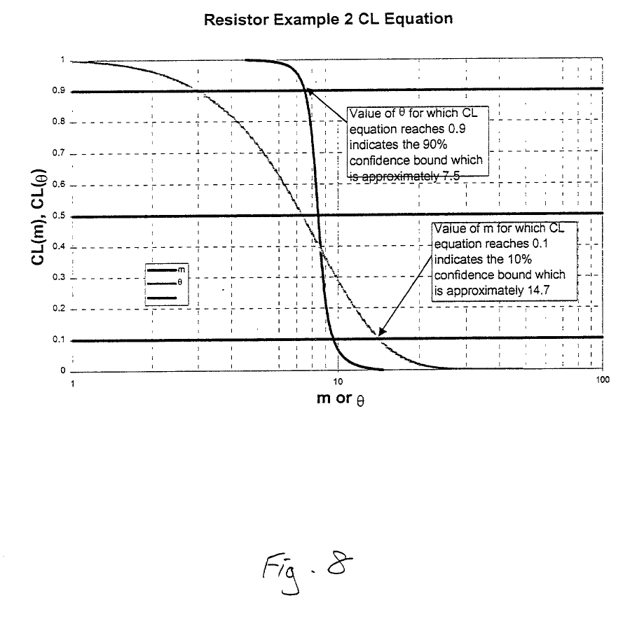

For determining the confidence bounds for θ, a similar exercise is completed, except that the volume would be divided by a plane at a constant value of θ which has been determined so that the remaining fraction of volume is the specified confidence bound value. A two-dimensional condensation of the three-dimensional solutions for m and θ are shown in FIG. 8.

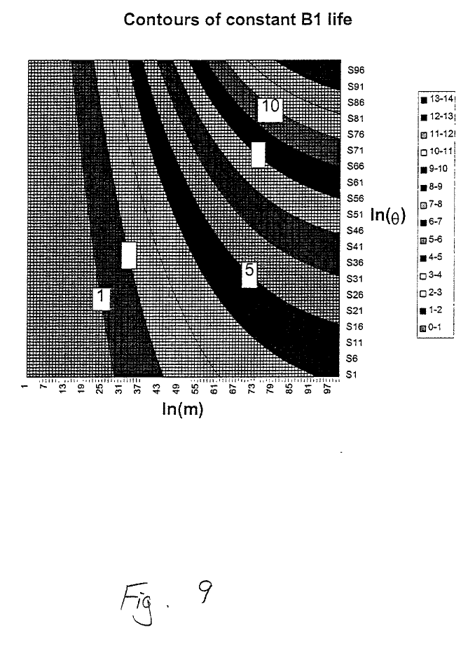

To address the problem of determining the confidence levels (CL) on the life at the time when 1% have failed is slightly more complex. It is still necessary to integrate the volume under the surface, but the limit of integration in the numerator of the CL equation must specify values of constant B1 life which appear as curves on the m, θ surface. FIG. 9 shows a plot of lines of constant B1 life.

This requires that the limits of integration of the inside integral are a function of the outer integral so that in every situation, the lower integration limit follows a line of constant B1 Life.

$$CL ( x ) = \frac{\begin{matrix}{\int }_{w = - ∞}^{∞} {\int }_{φ = ln ( x ) - \frac{1}{m} \cdot ln ( - ln ( 1 - 01 ) )}^{∞} \frac{{m}^{3}}{{θ}^{3}} \cdot \\ {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} ⅆ φ ⅆ w\end{matrix}}{{\int }_{w = - ∞}^{∞} {\int }_{φ = - ∞}^{∞} \frac{{m}^{3}}{{θ}^{3}} \cdot {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} ⅆ φ ⅆ w} \qquad ( Eq . 19 )$$

Determining a value of x for which CL(x) evaluates to 0.9, 0.5, and 0.1 yield the 90%, 50%, and 10% confidence bounds respectively for the B1 life. Other values of fraction failed are calculated by changing the 0.01 in the numerator's inside integral lower limit to the appropriate value. The results for the 90%, 50%, and 10% confidence bounds are 1.7, 3.4, and 6.3 hours respectively.

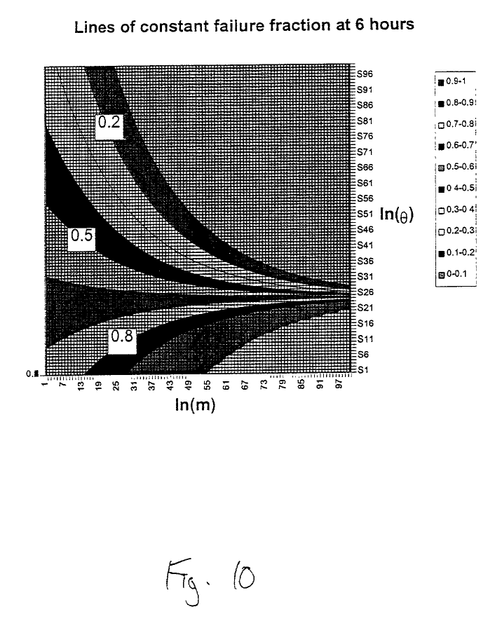

The last question for example 2 was to determine the confidence bounds on the failed fraction at 6 hours. Just as with the calculation of confidence on life given a failed fraction, the limit of the volume integral is a curved boundary defined by curves of constant failed fraction at 6 hours. These contours are illustrated in FIG. 10.

$$CL ( ff ) = \frac{\begin{matrix}{\int }_{w = - ∞}^{∞} {\int }_{φ = ln ( 6 ) - \frac{1}{m} \cdot ln ( - ln ( 1 - ff ) )}^{∞} \frac{{m}^{3}}{{θ}^{3}} \cdot \\ {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} ⅆ φ ⅆ w\end{matrix}}{{\int }_{w = - ∞}^{∞} {\int }_{φ = - ∞}^{∞} \frac{{m}^{3}}{{θ}^{3}} \cdot {( \frac{7 \cdot 8 \cdot 9}{{θ}^{3}} )}^{m - 1} \cdot {ⅇ}^{- ( \frac{{7}^{m} + {8}^{m} + {9}^{m}}{{θ}^{m}} )} ⅆ φ ⅆ w} \qquad ( Eq . 20 )$$

The CL equation is then modified to Eq. 20 to determine the failure fraction at the appropriate CL value. Determining a value of ff for which CL(ff) evaluates to 0.9, 0.5, and 0.1 yield the 90%, 50%, and 10% confidence bounds respectively on the failed fraction at 6 hours. The failed fractions at other life values are calculated by changing the 6 in the numerator's inside integral lower limit to the appropriate value. The results for the 90%, 50%, and 10% confidence bounds on fraction failed at 6 hours are 34.7%, 7.1%, and 0.48% respectively.

A complete summary of the answers for example 2 follow in table 2-1.

TABLE 2-1
Summary of answers for example problem 2.

| | | | | Failed |
|---|---|---|---|---|
| Confidence | | | Value of B1 | Fraction at 6 |
| bound value | Value of m_{b} | Value of θ_{b} | Life | hours |
| 90% | 3.1 | 7.5 hours | 1.7 hours | 34.6% |
| 50% | 7.7 | 8.5 hours | 3.4 hours | 7.1% |
| 10% | 14.6 | 9.7 hours | 6.3 hours | 0.48% |

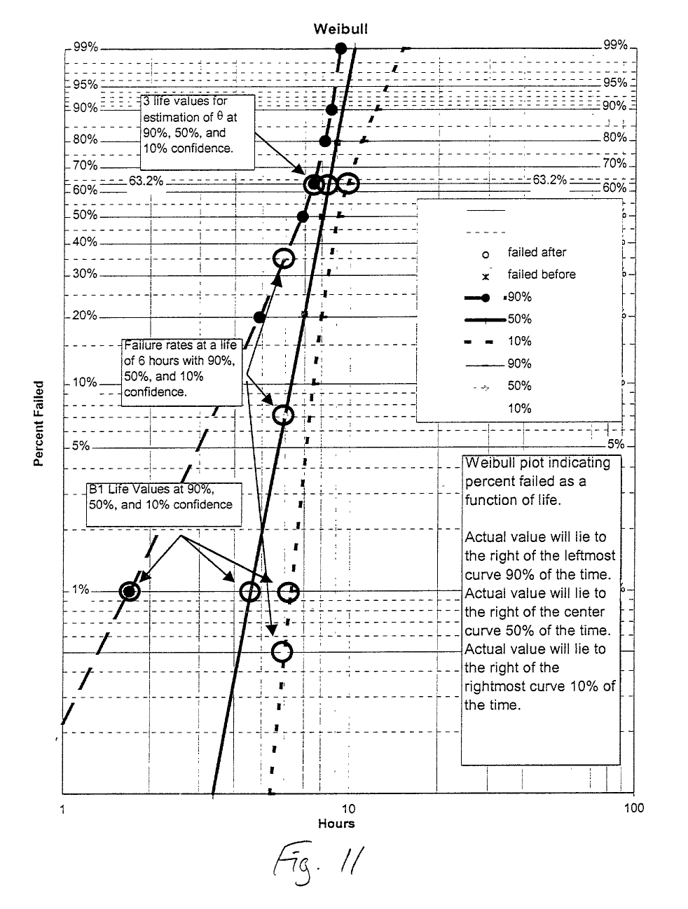

FIG. 11 is a common format for the presentation of the results of Table 2-1. All of the data with the exception of the confidence levels on m are presented in a single graph along with additional information.

This completes example 2. This problem is not beyond the use of tools already available but is included to demonstrate the use of the CL equation. However, this problem becomes not readily solvable with accurate confidence bounds if arbitrary censoring is introduced. For example, if two more resistors were included in the study, one of which was removed from the test at 7.5 hours, and one of which failed some time in the interval between 10 and 11 hours, the disclosed method would solve in the identical fashion.

These problems illustrate one- and two-parameter problems. The addition of more parameters requires more levels of integration. Nonetheless, the basic idea is the same. These problems concentrate on the exponential and Weibull distributions. Other distribution types, including normal and log-normal distributions can be handled in a similar manner.

Although the invention has been described in detail with reference to a certain preferred embodiment, variations and modifications exist within the scope and spirit of the invention as described and defined in the following claims.

What is claimed is:

1. A method of determining the probability that a percentage of a plurality of parts will fail after a given time using a sample of part failures and the Weibull distribution type, the method comprising the steps of
choosing an initial percentage and a value for a random variable for use as a limit in the Weibull distribution type, the Weibull distribution type having a scale parameter and a shape parameter;
defining a first plurality of logarithmic ranges, wherein the scale parameter has a substantially equal probability of occurring;
defining a second plurality of logarithmic ranges, wherein the shape parameter has a substantially equal probability of occurring;
determining a two-dimensional array of probabilities of obtaining the sample of part failures, wherein one dimension of the array includes the first plurality of logarithmic ranges, and a second dimension of the array includes the second plurality of logarithmic ranges;
selecting a level of significance of the values of the probabilities and discontinuing the two-dimensional array when the values do not meet that level of significance;
using the Weibull distribution type to create an associated second array of percentages based on the chosen random variable, an associated shape parameter, and an associated scale parameter, wherein the associated shape parameter and the associated scale parameter relate to the particular location on the array of probabilities;
dividing the array of probabilities based on whether the associated second array of percentages are above or below the chosen initial percentage;
determining a first sum of all of the values of the array of probabilities;
determining a second sum of all of the values of one of the parts of the probabilities;
comparing the first sum and the second sum to determine the probability that a percentage of a plurality of parts will fail after the given time, and
taking one of a plurality of actions including creating a graphical representation of the comparison, using the comparison to predict costs associated with failure occurrences over a period of time, and using the comparison to determine whether to re-engineer the part.

2. The method of claim 1, wherein the distribution model is a Weibull distribution defined by the cumulative distribution function:
$$F ( x ) = 1 - {ⅇ}^{- {( \frac{x}{θ} )}^{m}} .$$

3. The method of claim 2, further comprising the step of changing the value of one of the cumulative distribution function and the random variable such that the determined odds substantially equal a desired value.

4. A method of determining a cumulative distribution function confidence bound comprising the steps of
providing a plurality of test data;
selecting a distribution model having a first parameter and a second parameter, wherein the distribution model is defined by a cumulative distribution function that is a function of a random variable;
assigning numeric values to the cumulative distribution function and the random variable such that the first parameter is a function of the second parameter;
determining a likelihood function from the test data and the distribution model;
integrating the likelihood function up to a selected limit in order to calculate a numerator, the selected limit being defined by the relationship between the first parameter and the second parameter;
integrating the entire likelihood function in order to calculate a denominator; and
calculating the confidence bound by dividing the numerator by the denominator.

5. The method of claim 4, wherein the distribution model is one selected from the group comprising a Weibull distribution, a Gamma distribution, a Beta distribution, a Gaussian distribution, and a F distribution.

6. The method of claim 4, wherein the distribution model is a Weibull distribution defined by the cumulative distribution function:
$$F ( x ) = 1 - {ⅇ}^{- {( \frac{x}{θ} )}^{m}} .$$

7. The method of claim 4, wherein the first parameter is a scale parameter.

8. The method of claim 4, wherein the second parameter is a shape parameter.

9. The method of claim 4, wherein an incremental volume under the likelihood function is defined by the product of the likelihood function, a change in the logarithm of the first parameter, and a change in the logarithm of the second parameter.

10. The method of claim 4, wherein an incremental volume under a quotient of the likelihood function and one of the first parameter and the second parameter is defined by the product of the quotient, a change in the first parameter, and a change in the logarithm of the second parameter.

11. The method of claim 4, wherein an incremental volume under a quotient of the likelihood function and the product of the first parameter and the second parameter is defined by the product of the quotient, a change in the first parameter, and a change in the second parameter.

12. The method of claim 4, further comprising the step of changing the value of one of the cumulative distribution function and the random variable such that the calculated confidence bound substantially equals a desired value.

13. The method of claim 4, further comprising the step of taking one of a plurality of actions including creating a graphical representation of the calculated confidence bound, and using the confidence bound to predict risks associated with occurrences over a period of time.
